(19) United States
(12) Patent Application Publication
(10) Pub. No.: US 2026/0342551 A1
(43) Pub. Date: Oct. 29, 2026

(54) METHOD FOR UPDATING PRE-SHARED KEY IN QUANTUM DIRECT COMMUNICATION TECHNIQUE COMPRISING USER AUTHENTICATION, AND DEVICE THEREFOR

(71) Applicant: LG Electronics Inc., Seoul (KR)

(72) Inventors: Byungkyu AHN, Seoul (KR); Sangrim LEE, Seoul (KR); Jayeong KIM, Seoul (KR); Hojae LEE, Seoul (KR)

(21) Appl. No.: 19/114,606

(22) PCT Filed: Sep. 23, 2022
(86) PCT No.: PCT/KR2022/014302

§ 371 Date: Mar. 24, 2025

(51) Int. Cl. H04L 9/08; H04W 12/0471; H04W 12/069

(52) U.S. Cl. CPC H04L 9/0852; H04W 12/0471; H04W 12/069

(57) ABSTRACT

The present disclosure provides a method and a procedure for updating a pre-shared key from a QBER checking sequence used for QBER estimation, the pre-shared key being used in a process of performing user authentication by a transmitting/receiving end in a quantum direct communication system. More particularly, the method comprises the steps of: transmitting quantum information encoded in a quantum state to a receiving end; performing user authentication on the basis of a pre-shared authentication key with the receiving end; transmitting, to the receiving end, position information regarding the position of information for quantum bit error rate (QBER) estimation inside the transmitted quantum information; receiving, from the receiving end, information obtained by encrypting a value on the basis of the pre-shared key, the value being obtained by the receiving end through measurement of the information for QBER estimation on the basis of the position information; performing the QBER estimation on the basis of a value obtained by the transmitting end by decrypting information encrypted on the basis of the pre-shared key, on the basis of the pre-shared key; and updating the pre-shared key to the information for QBER estimation, which has been used for the QBER estimation, on the basis of (i) the user authentication result and (ii) the QBER estimation result.

### TECHNICAL FIELD

The present disclosure relates to a quantum communication system, and more particularly, to a method for updating a pre-shared key used for user authentication in a quantum direct communication system, and a device therefor.

### BACKGROUND ART

Wireless communication systems have been widely deployed to provide various types of communication services such as voice or data. In general, the wireless communication system is a multiple access system capable of supporting communication with multiple users by sharing available system resources (bandwidth, transmission power, etc.). Examples of multiple access systems include a Code Division Multiple Access (CDMA) system, a Frequency Division Multiple Access (FDMA) system, a Time Division Multiple Access (TDMA) system, a Space Division Multiple Access (SDMA) system, an Orthogonal Frequency Division Multiple Access (OFDMA) system, a Single Carrier Frequency Division Multiple Access (SC-FDMA) system, and an Interleave Division Multiple Access (IDMA) system. In addition, research is continuing on quantum communication, a next-generation communication technology that can overcome the limitations of existing information and communication, such as security and ultra-high-speed computation, by applying quantum mechanical characteristics to the information and communication field. Unlike the existing communication based on binary bit information, quantum communication provides a means of generating, transmitting, processing, and storing information in a superposition of 0 and 1. In existing communication technologies, wavelength or amplitude is used to transmit information between a transmitting end and a receiving end, whereas, in quantum communication, photons, the smallest unit of light, are used to transmit information between the transmitting end and the receiving end.

### DISCLOSURE

### Technical Problem

An aspect of the present disclosure is to provide a method and device for performing user authentication in a quantum direct communication system.

Furthermore, an aspect of the present disclosure is to provide a method and device for updating a pre-shared key for user authentication in a quantum direct communication system where no secret key is generated.

Furthermore, an aspect of the present disclosure is to provide a method and device for updating a pre-shared key for user authentication by using information that is discarded after used for QBER estimation.

Furthermore, an aspect of the present disclosure is to provide a method and device for reusing information used for QBER estimation to update a pre-shared key for user authentication after QBER estimation, by guaranteeing the security of that information.

The technical objects of the present disclosure are not limited to the aforementioned technical objects, and other technical objects, which are not mentioned above, will be apparently appreciated by a person having ordinary skill in the art from the following description.

### Technical Solution

The present disclosure provides a method for updating a pre-shared key used for user authentication in a quantum direct communication system, and a device therefor.

In the present disclosure, a method for a transmitting end to perform user authentication in a quantum direct communication system is provided. The method comprises: transmitting quantum information encoded in a quantum state to a receiving end; performing user authentication on the basis of a pre-shared authentication key with the receiving end; transmitting, to the receiving end, position information regarding the position of information for quantum bit error rate (QBER) estimation inside the transmitted quantum information; receiving, from the receiving end, information obtained by encrypting a value on the basis of the pre-shared key, the value being obtained by the receiving end through measurement of the information for QBER estimation on the basis of the position information; performing the QBER estimation on the basis of a value obtained by the transmitting end by decrypting information encrypted on the basis of the pre-shared key, on the basis of the pre-shared key; and updating the pre-shared key to the information for QBER estimation, which has been used for the QBER estimation, on the basis of (i) the user authentication result and (ii) the QBER estimation result.

In the present disclosure, the information obtained by encrypting a value on the basis of the pre-shared key, the value being obtained by the receiving end through measurement of the information for QBER estimation, is a value produced through an XOR operation between (i) the value obtained by the receiving end through measurement of the information for QBER estimation and (ii) the pre-shared key.

In the present disclosure, the value obtained by decrypting information encrypted on the basis of the pre-shared key is a value obtained through an XOR operation between (i) the information encrypted on the basis of the pre-shared key, received by the transmitting end and (ii) the pre-shared key.

In the present disclosure, the pre-shared key is updated to the information for QBER estimation, which has been used for the QBER estimation, based on (i) the user authentication result and (ii) the QBER estimation result being both successful.

In the present disclosure, the quantum information includes (i) the information for QBER estimation and (ii) information obtained by encrypting message information.

In the present disclosure, the method further comprises: transmitting, to the receiving end, additional information for decrypting the encrypted message information, based on (i) the user authentication result and (ii) the QBER estimation result being both successful.

In the present disclosure, the method further comprises: performing a procedure for matching (i) the value of the information for QBER estimation, generated by the transmitting end and (ii) the value obtained by the transmitting end by decrypting information encrypted by the receiving end on the basis of the pre-shared key, based on (i) the user authentication result and (ii) the QBER estimation result being both successful and (iii) the value of the QBER estimation result not being zero.

In the present disclosure, a communication line for quantum communication between the transmitting end and the receiving end is changed, based on at least one of (i) the user authentication result and (ii) the QBER estimation result being a failure.

In the present disclosure, the pre-shared key is updated to a backup pre-shared key used for updating the pre-shared key when changing the communication line, based on at least one of (i) the user authentication result and (ii) the QBER estimation result being a failure.

In the present disclosure, the method further comprises: exchanging (i) the pre-shared key and (ii) the backup pre-shared key with the receiving end.

In the present disclosure, a transmitting end that performs user authentication in a quantum communication system is provided. The transmitting end comprises: a transmitter for transmitting a wireless signal; a receiver for receiving a wireless signal; at least one processor; and at least one computer memory operably connectable to the at least one processor, and storing instructions that, when executed by the at least one processor, perform operations, the operations including: transmitting quantum information encoded in a quantum state to a receiving end; performing user authentication on the basis of a pre-shared authentication key with the receiving end; transmitting, to the receiving end, position information regarding the position of information for quantum bit error rate (QBER) estimation inside the transmitted quantum information: receiving, from the receiving end, information obtained by encrypting a value on the basis of the pre-shared key, the value being obtained by the receiving end through measurement of the information for QBER estimation on the basis of the position information; performing the QBER estimation on the basis of a value obtained by the transmitting end by decrypting information encrypted on the basis of the pre-shared key, on the basis of the pre-shared key; and updating the pre-shared key to the information for QBER estimation, which has been used for the QBER estimation, on the basis of (i) the user authentication result and (ii) the QBER estimation result.

In the present disclosure, a method for a receiving end to perform user authentication in a quantum direct communication system is provided. The method comprises: receiving quantum information encoded in a quantum state from a transmitting end; performing user authentication on the basis of a pre-shared authentication key with the transmitting end; receiving, from the transmitting end, position information regarding the position of information for quantum bit error rate (QBER) estimation inside the received quantum information; transmitting, to the transmitting end, information obtained by encrypting a value on the basis of the pre-shared key, the value being obtained by the receiving end through measurement of the information for QBER estimation on the basis of the position information; performing the QBER estimation, on the basis of the pre-shared key, the QBER estimation being performed on the basis of a value obtained by the transmitting end by decrypting information encrypted on the basis of the pre-shared key; and updating the pre-shared key to the information for QBER estimation, which has been used for the QBER estimation, on the basis of (i) the user authentication result and (ii) the QBER estimation result.

In the present disclosure, a receiving end that performs user authentication in a quantum communication system is provided. The receiving end comprises: a transmitter for transmitting a wireless signal; a receiver for receiving a wireless signal; at least one processor; and at least one computer memory operably connectable to the at least one processor, and storing instructions that, when executed by the at least one processor, perform operations, the operations including: receiving quantum information encoded in a quantum state from a transmitting end; performing user authentication on the basis of a pre-shared authentication key with the transmitting end; receiving, from the transmitting end, position information regarding the position of information for quantum bit error rate (QBER) estimation inside the received quantum information; transmitting, to the transmitting end, information obtained by encrypting a value on the basis of the pre-shared key, the value being obtained by the receiving end through measurement of the information for QBER estimation on the basis of the position information; performing the QBER estimation, on the basis of the pre-shared key, the QBER estimation being performed on the basis of a value obtained by the transmitting end by decrypting information encrypted on the basis of the pre-shared key; and updating the pre-shared key to the information for QBER estimation, which has been used for the QBER estimation, on the basis of (i) the user authentication result and (ii) the QBER estimation result.

In the present disclosure, a non-transitory computer readable medium (CRM) that stores one or more instructions is provided. The one or more instructions being executable by one or more processors and include: transmitting quantum information encoded in a quantum state to a receiving end; performing user authentication on the basis of a pre-shared authentication key with the receiving end; transmitting, to the receiving end, position information regarding the position of information for quantum bit error rate (QBER) estimation inside the transmitted quantum information; receiving, from the receiving end, information obtained by encrypting a value on the basis of the pre-shared key, the value being obtained by the receiving end through measurement of the information for QBER estimation on the basis of the position information; performing the QBER estimation on the basis of a value obtained by the transmitting end by decrypting information encrypted on the basis of the pre-shared key, on the basis of the pre-shared key; and updating the pre-shared key to the information for QBER estimation, which has been used for the QBER estimation, on the basis of (i) the user authentication result and (ii) the QBER estimation result.

In the present disclosure, a device comprising one or more memories and one or more processors functionally connected to the one or more memories is provided. The one or more processors control the device to: transmit quantum information encoded in a quantum state to a receiving end; perform user authentication on the basis of a pre-shared authentication key with the receiving end; transmit, to the receiving end, position information regarding the position of information for quantum bit error rate (QBER) estimation inside the transmitted quantum information; receive, from the receiving end, information obtained by encrypting a value on the basis of the pre-shared key, the value being obtained by the receiving end through measurement of the information for QBER estimation on the basis of the position information; perform the QBER estimation on the basis of a value obtained by the transmitting end by decrypting information encrypted on the basis of the pre-shared key, on the basis of the pre-shared key; and update the pre-shared key to the information for QBER estimation, which has been used for the QBER estimation, on the basis of (i) the user authentication result and (ii) the QBER estimation result.

### Advantageous Effects

The present disclosure has the effect of carrying out user authentication in a quantum direct communication system.

Furthermore, the present disclosure has the effect of updating a pre-shared key for user authentication in a quantum direct communication system where no secret key is generated.

Furthermore, the present disclosure has the effect of updating a pre-shared key for user authentication by using information that is discarded after used for QBER estimation.

Furthermore, the present disclosure has the effect of reusing information used for QBER estimation to update a pre-shared key for user authentication after QBER estimation, by guaranteeing the security of that information.

Furthermore, the present disclosure has the effect of saving resources since no separate resources may be needed to generate a pre-shared key for user authentication.

Advantages which can be obtained in the present disclosure are not limited to the aforementioned effects and other unmentioned effects will be clearly understood by those skilled in the art from the following description.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates a method of processing a transmitted signal applicable to the present disclosure.

FIG. 4 illustrates another example of a wireless device applicable to the present disclosure.

FIG. 5 illustrates an example of a hand-held device applicable to the present disclosure.

FIG. 6 illustrates physical channels applicable to the present disclosure and a signal transmission method using the same.

FIG. 7 illustrates a structure of a radio frame applicable to the present disclosure.

FIG. 8 illustrates a slot structure applicable to the present disclosure.

FIG. 9 illustrates an example of a communication structure providable in a 6G system applicable to the present disclosure.

FIG. 10 is a view showing an example of a structure of a quantum direct communication protocol.

FIG. 11 is a view showing an example of an overall configuration and overall implementation process of the existing single photon-based DL04 QSDC technique.

FIG. 12 is a view showing an example of implementation of the one way QDC scheme.

FIG. 13 is a view showing an example of a man-in-the-middle attack that may occur in quantum communication.

FIG. 14 is a view showing an example of an authentication scheme based on Wegman & Carter Authentication (WCA).

FIG. 15 is a view showing an example of a preshared key updating method in the QKD technique.

FIG. 16 is a view for describing that information transmitted over a quantum channel in the QDC method cannot be used for updating a preshared key.

FIG. 17 is a view showing an example of a QBER estimation process performed in the QDC method.

Referring to FIG. 18, the QBER estimation process in the method proposed in the present disclosure will be described in concrete detail.

FIG. 19 is a flowchart showing an example of implementation of a user authentication procedure based on a preshared key updating process using QBER checking sequence information, proposed in the present disclosure.

FIG. 20 is a flowchart showing a procedure in a two way QDC protocol to which a method proposed in the present disclosure is applied.

FIG. 21 is a flowchart showing a procedure in a one way QDC protocol to which a method proposed in the present disclosure is applied.

FIG. 22 is a flowchart showing an example of how a user authentication method proposed in the present disclosure is performed by a transmitting end.

FIG. 23 is a flowchart showing an example of how a user authentication method proposed in the present disclosure is performed by a receiving end.

### MODE FOR DISCLOSURE

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

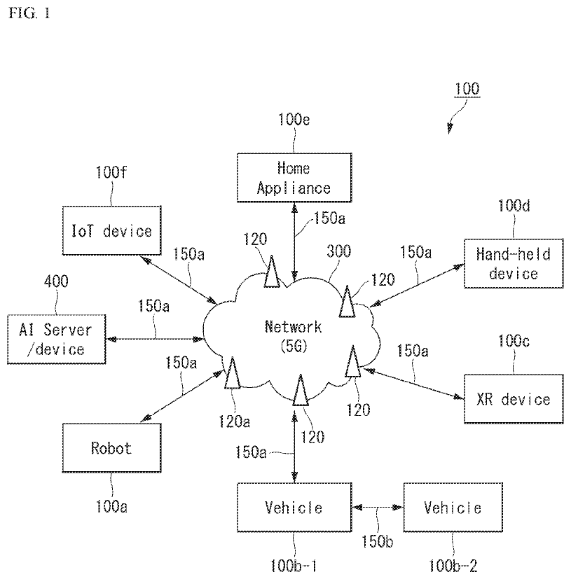

FIG. 1 illustrates an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a. 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

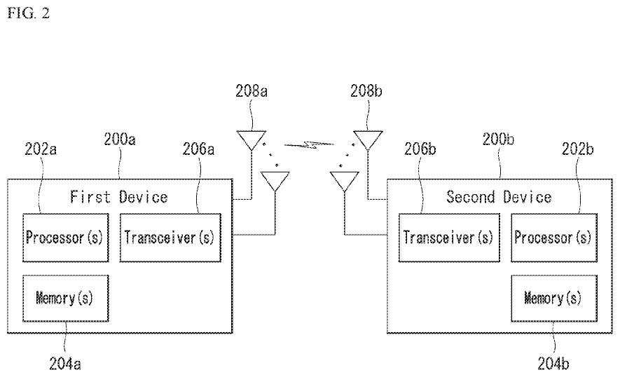

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to (the wireless device 100x, the base station 120) and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical). MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs. SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

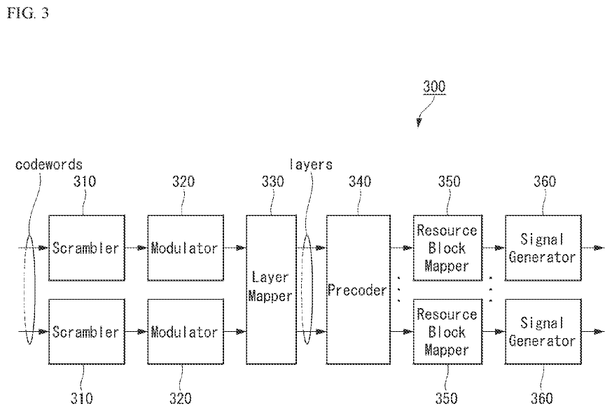

FIG. 3 illustrates a method of processing a transmitted signal applicable to the present disclosure. For example, the transmitted signal may be processed by a signal processing circuit. At this time, a signal processing circuit 1200 may include a scrambler 300, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. In addition, for example blocks 310 to 350 may be implemented in the processors 202a and 202b of FIG. 2 and a block 360 may be implemented in the transceivers 206a and 206b of FIG. 2, without being limited to the above-described embodiments.

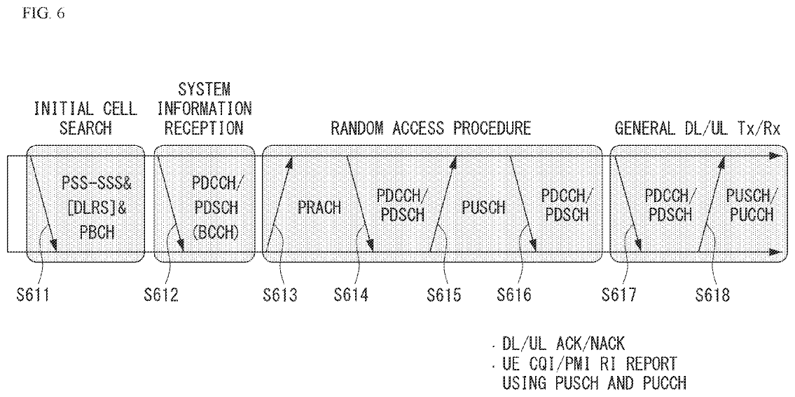

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder

### Structure of Wireless Device Applicable to the Present Disclosure

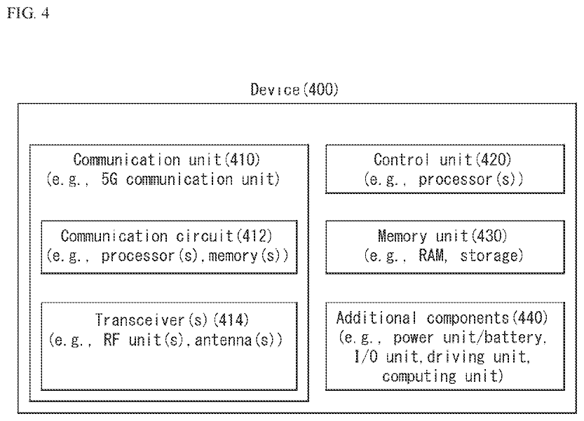

FIG. 4 illustrates another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 400 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 320 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

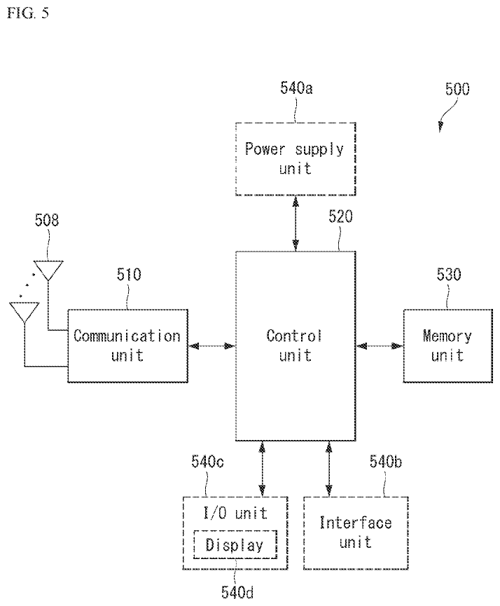

FIG. 5 illustrates an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 500. In addition, the memory unit 430 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 440c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 5 illustrates physical channels applicable to the present disclosure and a signal transmission method using the same.

The UE which is turned on again in a state of being turned off or has newly entered a cell performs initial cell search operation in step S1011 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

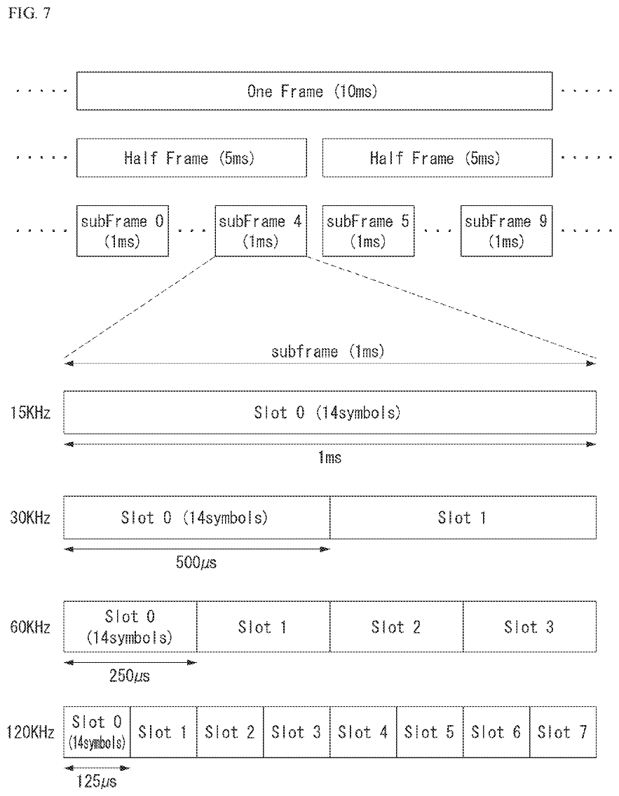

FIG. 7 illustrates a structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM(A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| | | | |
|---|---|---|---|
| 5 | 14 | 320 | 32 |

TABLE 2

| | | | |
|---|---|---|---|
| 2 | 12 | 40 | 4 |

In Tables 1 and 2 above, Nslotsymb may indicate the number of symbols in a slot, Nframe,μslot may indicate the number of slots in a frame, and Nsubframe,μslot may indicate the number of slots in a subframe.

In addition, in a system, to which the present disclosure is applicable, OFDM(A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise w % ben the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| | | |
|---|---|---|
| FR1 | 410 MHz-7125 MHz | 15, 30, 60 kHz |
| FR2 | 24250 MHz-52600 MHz | 60, 120, 240 kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments. The THz band will be described below.

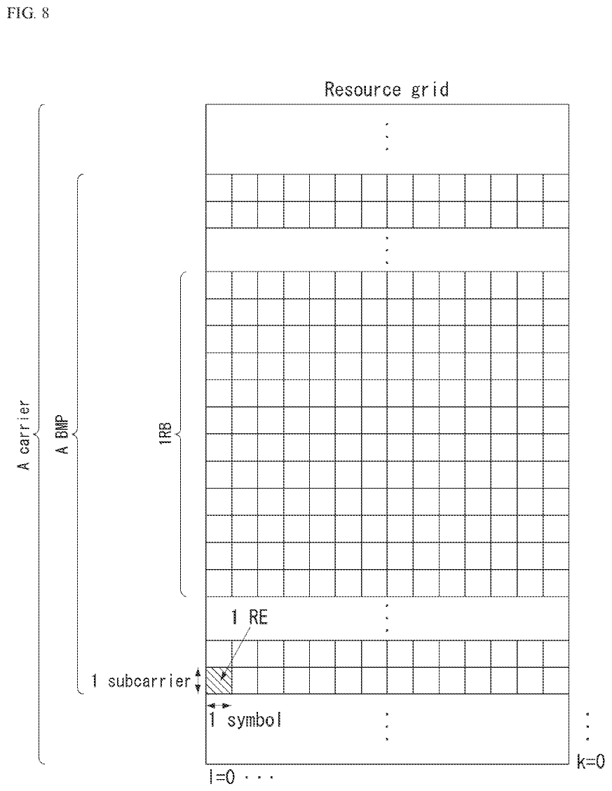

FIG. 8 illustrates a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P)RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | |
|---|---|
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

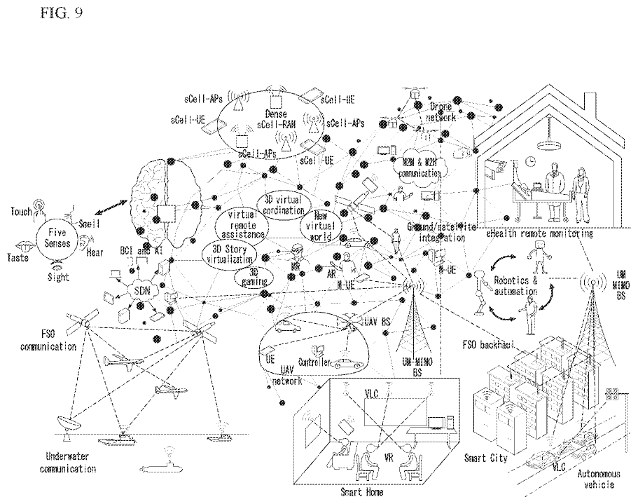

FIG. 9 illustrates an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Quantum Communication

Quantum communication is a next-generation communication technology that can overcome the limitations of existing information and communication, such as security and ultra-fast computation, by applying quantum mechanical properties to the information and communication field. The quantum communication provides a means to generate, transmit, process, and store information in the form that cannot be expressed or is difficult to express in the form of 0 and 1 according to binary bit information used in existing communication technologies. In the existing communication technologies, wavelengths, amplitudes, or the like have been used for information transmission between a transmitting terminal and a receiving terminal, but in the quantum communication, a photon, which is the smallest unit of light, is used for the information transmission between the transmitting terminal and the receiving terminal. In particular, the quantum communication can utilize quantum uncertainty, quantum irreversibility, and non-cloning for the polarization or phase difference of photons (light), and thus the quantum communication has the characteristic of enabling communication with perfect security. The quantum communication can also enable ultra-fast communication using quantum entanglement under certain conditions.

The present disclosure proposes a method and device for updating a pre-shared symmetric key which needs to be discarded and updated after a one-time authentication in order to guarantee security, in a quantum direct communication method comprising a pre-shared symmetric key-based, user authentication technique.

Prior to describing the method proposed in the present disclosure, a quantum direct communication method and a user authentication method, to which the method proposed in the present disclosure is applicable, will be described first in order to help understanding.

### Quantum Direct Communication (ODC)

QDC is a technique that encodes classical message information into a quantum state and transmits it via a quantum channel. Like QKD, which is a quantum secret key transmission technique used in existing security communication networks. QDC can guarantee security against an eavesdropper through QBER estimation. QDC may be generally divided into a scheme that uses entanglement and a scheme that uses single photons, and the method proposed in the present disclosure is implemented more preferably in the single photon-based scheme, and the single photon-based QDC scheme may be divided into a two-way mode and a one-way mode.

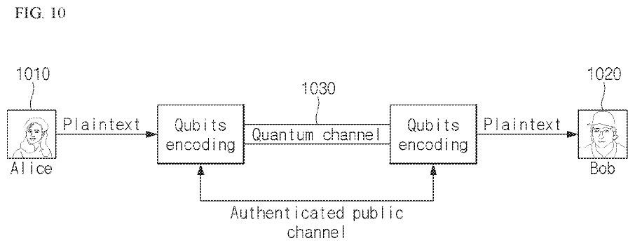

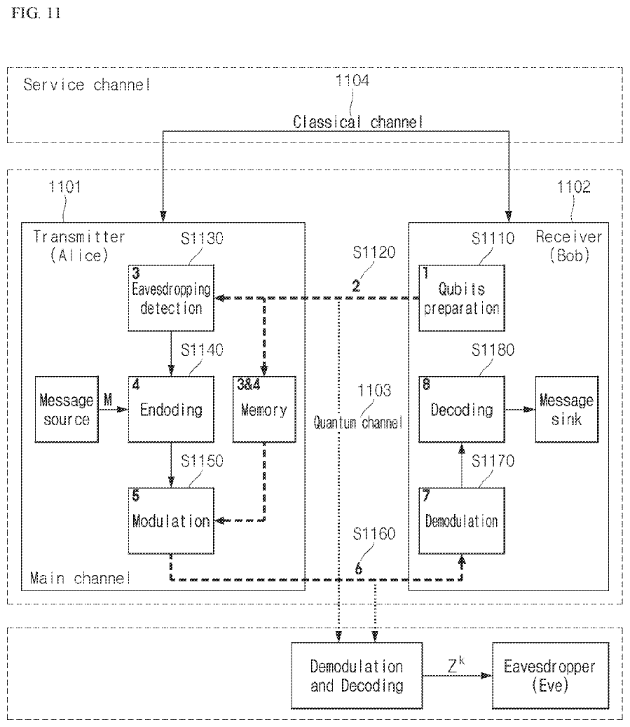

FIG. 10 is a view showing an example of a structure of a quantum direct communication protocol. Referring to FIG. 10, a transmitting end 1010 may encode classical message information into a quantum state and transmit it to a receiving end 1020 via a quantum channel 1030, and a user-authenticated, classical (public) channel 1040 may be formed between the transmitting end 1010 and the receiving end 1020. The two-way QDC method and the one-way QDC method will be discussed below.

### Two Way ODC: DL 04 Quantum Secure Direct Communication (OSDC)

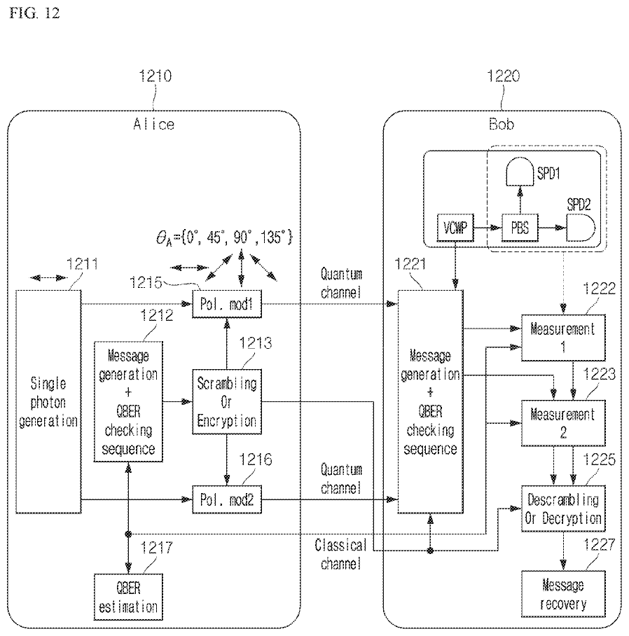

The existing single photon-based DL04 QSDC technique, which transmits 1 bit of classical information per photon, has an overall system configuration in which transmitting/receiving ends, a quantum channel, and a classical channel are configured as shown in FIG. 11, and has the advantage that no information leakage occurs in relation to message information transmitted over a quantum channel, and an information transmission process is implemented as follows.

FIG. 11 is a view showing an example of an overall configuration and overall implementation process of the existing single photon-based DL04 QSDC technique. As opposed to the QKD technique, which is a secret key sharing protocol in a quantum cryptographic communication system, the single photon-based DL04 QSDC technique is a technique that transmits messages (information) to be sent directly via a quantum channel, in which 1 bit of classical information per photon may be transmitted.

Referring to FIG. 11, the DL04 QSDC protocol by which the DL04 QSDC technique is implemented may include transmitting/receiving ends 1101 and 1102, a quantum channel 1103, and a classical channel 1104.

S1110: The receiving end (Bob) 1102 configures a polarization information-based single photon row. Each single photon contained in the single photon row configured above may be generated with randomness in one of four states

$$\vert 0 〉 = [ \begin{matrix}1 \\ 0\end{matrix} ] , \vert 1 〉 = [ \begin{matrix}0 \\ 1\end{matrix} ] , \vert + 〉 = \frac{1}{\sqrt{2}} [ \begin{matrix}1 \\ 1\end{matrix} ] , and \vert - 〉 = \frac{1}{\sqrt{2}} [ \begin{matrix}1 \\ - 1\end{matrix} ] .$$

S1120: Next, the receiving end 1102 transmits the generated single photon row to the transmitting end (Alice) 1101.

S1130: Afterwards, the transmitting end 1101 randomly chooses some of the single photons contained in the received single photon row and then selects an orthogonal or diagonal basis and performs measurement. At this time, the transmitting end 1101 may inform the receiving end 1102 of a selected position, a measurement basis value, and a measurement result over a public channel. The receiving end 1102 may estimate QBER, the error rate, and determine the presence of an eavesdropper, based on the information received from the transmitting end 1101. If the value of QBER is higher than a reference value for determining eavesdropping, the receiving end 1102 determines that the quantum channel is not secure and discontinues communication. In the reverse case, the receiving end 1102 may perform subsequent operations.

S1140-S1150: The transmitting end 1101 encodes a message (information) to be sent based on the rest of the single photon row, except for the single photon used for QBER estimation, among all the single photons contained in the single photon row received in the step S1120. Here, if the information contained in the message is 0, then the encoding may be performed through an identity operation denoted by I which elicits no change, and if the information is 1, the encoding may be performed by a unitary operation defined as U. The unitary operation may include U|0 [symbol] =−|1 [symbol] , U|1 [symbol] =|0 [symbol] , U|+ [symbol] =|− [symbol] , and U|− [symbol] =−|+ [symbol] .

S1160: Next, the transmitting end 1101 transmits the encoded single photon row to the receiving end 1102. Here, the receiving end 1102 measures each single photon by using the same basis information as an initial measurement basis in order to read a message (information) from the received single photon row. Part of the same basis information as the initial measurement basis is used for QBER estimation, and the receiving end 1102 may receive, from the transmitting end 1101, the positions of photons to be used for QBER estimation and the values of encoding bits over the public channel.

S1170-S1180: The receiving end 1102 may determine the values of parameters to be used for decoding based on the measured QBER value, and perform decoding of the received message.

Through the steps S1110 to S1180, in the QSDC technique, the message information generated by the transmitting end may be securely transmitted to the receiving end via the quantum channel. That is, since the transmitting end may perform QBER estimation of an initial state generated by the receiving end, and check whether the initial state is secure against an eavesdropper based on the QBER estimation, the message information may be encoded in the initial state in which the security against an eavesdropper is guaranteed. Thus, even if there is an eavesdropper in a backward quantum channel, the eavesdropper who has no way of knowing the value of the initial state cannot obtain any meaningful message information from an encoded message even by eavesdropping, and therefore security can be guaranteed.

### One way QDC

One way QDC has the benefit of minimizing loss of transmission information caused by the long transmission distance and quantum memory use in the two way scheme. FIG. 12 shows an overall configuration view of a single photon pair-based one way QDC protocol. In one way QDC, unlike in the existing two way QDC, classical information to be sent is unidirectionally transmitted along with QBER checking information via a quantum channel, and if it is determined that security is guaranteed as a result of QBER estimation performed between the transmitting end and the receiving end, the receiving end additionally receives information related to message recovery from the transmitting end via a classical channel. FIG. 12 is a view showing an example of implementation of the one way QDC scheme. Referring to FIG. 12, the transmitting end 1210 generates a single photon pair for polarization coding in a single photon generator 1211. A message information sequence and a checking sequence for QBER estimation are generated, and a combined transmission information sequence, which is a random combination of the message information sequence and the checking sequence for QBER estimation, is generated (1212). Due to this, an eavesdropper or the receiving end does not know position information of the checking sequence, which makes it impossible to find the location of a signal used for QBER estimation unless additional position information is shared.

Afterwards, the transmitting end 1210 performs scrambling or encryption on the combined transmission information sequence (1213). Through the scrambling or encryption, the eavesdropper is not able to gain meaningful information even if transmission message information is revealed to the eavesdropper. In this case, the scrambling or encryption may be performed only on the message information sequence contained in the combined transmission information sequence.

Afterwards, the transmitting end 1210 generates quantum information by performing polarization coding 1215 and 1216 on the transmission information, and transmits the generated quantum information to the receiving end 1220. In this case, the transmitting of the generated quantum information by the transmitting end 1210 to the receiving end 1220 may also be understood as transmitting a photon pair by the transmitting end 1210. For message information, the same polarization coding may be performed on the two photons, and for information used for QBER estimation, the same or different polarization coding may be performed on the two pairs.

Afterwards, the receiving end 1220 measures (1222 and 1223) the quantum information transmitted from the transmitting end 1210, and the receiving end 1220 selects (1221) one of two measurement basis pairs and performs measurement on the transmitted single photon pair.

Afterwards, the transmitting end 1210 transmits, to the receiving end 1220, information on the position of the checking sequence used for QBER estimation. In this case, the transmitting end 1210 and the receiving end 1220 may share basis information used for polarization coding/measurement. That is, only a measurement value corresponding to the position of a bit string for which the same basis is used for polarization coding/measurement by the transmitting/receiving ends is used as information measured (received) by the receiving end 1220. Based on the information on the position, the receiving end 1220 transmits, to the transmitting end 1210, a measurement result including information on bit values measured using the same basis as used for polarization coding by the transmitting end 1210, among the bit values contained in the measured result information.

The transmitting end 1210 performs QBER estimation (1217), and if it is determined that there is an eavesdropper, performs no additional operation. On the other hand, if it is determined that there is no eavesdropper, the transmitting end 1210 transmits, to the receiving end 1220, additional information required for decrypting the scrambled or encrypted message information.

Afterwards, the receiving end 1220 decrypts (1225 and 1227) the measured encrypted information by performing a process of reversing the encryption at the transmitting end 1210, by using the additional information.

### User Authentication

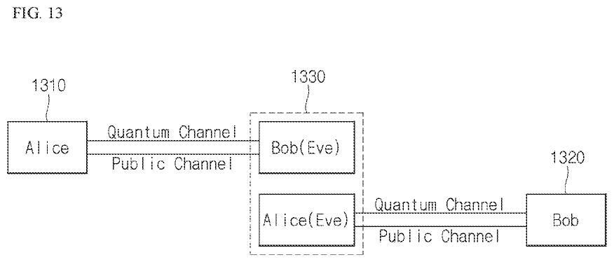

In quantum communication, the security of information transmitted via a quantum channel is guaranteed through the non-cloning theorem which is a quantum mechanical characteristic. More specifically, through a QBER (Quantum Bit Error Rate) estimation process using part of information transmitted via a quantum channel, it is possible to check whether message information transmitted via the quantum channel is eavesdropped by a third party, whereby the security of the transmitted message can be guaranteed. However, as shown in FIG. 13 which shows an example of a man-in-the-middle attack that can occur in quantum communication, if a man-in-the-middle, Eve, 1330 is present between Alice 1310, who is a transmitting end, and Bob 1320, who is a receiving end, and attempts a man-in-the-middle attack by pretending to be the receiving end to Alice 1310 and pretending to be the transmitting end to Bob 1320, it is not possible to check whether the man-in-the middle, Eve, 1330 performs a man-in-the-middle attack, based only on a result of QBER estimation through information transmission between Alice 1310 and Eve 1330 and a result of QBER estimation through information transmission between Eve 1330 and Bob 1320. Through the man-in-the-middle attack, the man-in-the-middle, Eve, 1330 is able to know the entire content of delivered data while relaying data between Alice 1310 and Bob 1320, and may also attempt to forge/falsify the data. Accordingly, in order to prevent a man-in-the-middle attack, a user authentication process is required to confirm whether the transmitting end and the receiving end, which are entities that exchange information, are authorized users.

Existing authentication techniques may be divided into hash function-based authentication schemes that include cryptographically strong elements and authentication schemes based on information-theoretic security. In the hash function-based authentication schemes, the probability of collision of hash functions is used as an authentication technology based on computational complexity, and a representative hash function-based technology is the SHA technique. However, since the hash function-based authentication schemes are based on computational complexity, it is highly likely that they will face a security threat in the future due to the emergence of quantum computers. In addition, in quantum cryptographic communication systems, an authentication technology using a keyed hash function family, which is a combination of a symmetric key and a hash function based on information theoretic security, is applied and used in order to enhance security, and quantum communication standardization organizations such as ETSI (European Telecommunications Standards Institute) adopts the scheme using a keyed hash function family as a standard authentication scheme. In the above scheme, a hash function called Strongly Universal Hashing is used as a message authentication code (MAC) algorithm to generate a message authentication code (MAC) used in an authentication process, and a symmetric key used as a one time pad (OTP) is additionally used in the generation process. This scheme is known to be the most secure scheme because there is a very low chance of information restoration from the MAC through a reversal process unless symmetric key information is known.

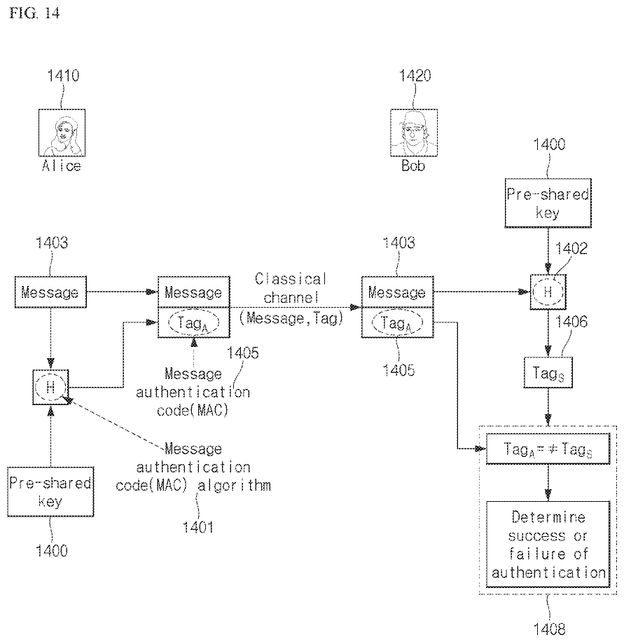

In quantum key distribution (QKD) protocols which are currently applied as a security technology of 4G LTE/5G, the WCA technique proposed by Wegman and Carter is adopted and used as a standard authentication technology, and a symmetric key generated in the form of a one time pad and a Strongly Universal Hash class are used to generate a tag as a MAC used for authentication. FIG. 14 is a view showing an example of an authentication scheme based on Wegman & Carter Authentication (WCA).

The authentication scheme of FIG. 14 is applicable for both user authentication for checking for a change of the transmitter/receiver during message transmission and message authentication for checking for a change of the content and order of message information. In FIG. 14, the transmitting end 1410 generates tag information 1405 serving as a MAC from the message information 1403 by using a pre-shared key 1400 and a MAC algorithm 1401, and a Hash function of a Strongly Universal Hash class is used as the MAC algorithm. In this case, the pre-shared key information 1400 allows for selecting which hash function hₖ to be used at Hs 1401 and 1402 of the transmitting and receiving ends 1410 and 1420, and the pre-shared key is assigned log₂|H| bits, wherein |H| represents the number of hash functions constituting a hash function set. The tag information 1405 is denoted by T=hₖ(m), and is obtained by passing a message m of the authentication process as an input through a hash function hₖ selected from the pre-shared key. Afterwards, the receiving end 1420 compares tag information 1406 of the receiving end 1420 obtained from the pre-shared key 1400 and hash function 1402 of the receiving end 1420 by using the message 1403 received by the receiving end 1420 with the tag information 1405 received from the transmitting end 1410, to check for a match between the two tag information and then determine (1408) whether authentication is successful.

The biggest reason why security is guaranteed in the user authentication scheme is because a preshared key only the transmitting/receiving ends agree on is used as a one time pad. The preshared key is discarded after used in a one time authentication process and then updated to a new preshared key, and this ensures security even if a man-in-the-middle gains this information, since the new preshared key is already in use by the time the man-in-the-middle intends to use the information. Accordingly, the preshared key updating method is essentially necessary in the above authentication technique.

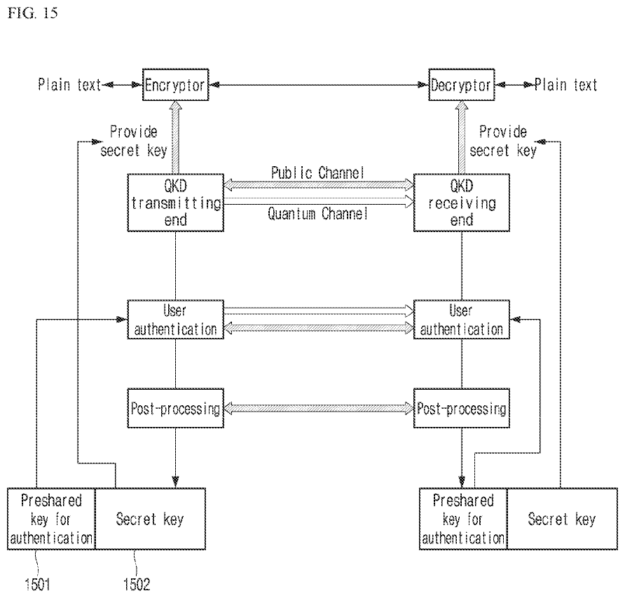

FIG. 15 is a view showing an example of a preshared key updating method in the QKD technique. Referring to FIG. 15, in the QKD technique, secret key information is transmitted over a quantum channel, and then a final symmetric key is generated through user authentication and post-processing processes. Through this, the transmitting/receiving ends may share the same key value. Afterwards, some of generated secret keys are provided as a preshared key 1501 for use the next time user authentication is performed, and the remaining symmetric keys are used as a secret key 1502 for quantum encryption communication. Although the preshared key updating method in FIG. 15 has the problem of the decrease in the efficiency of secret key generation since some of final secret keys are sacrificed and used as a preshared key for authentication, the scheme in FIG. 15 is currently adopted and applied as a standard scheme in ETSI which is a quantum communication-related standardization organization.

### DEFINITIONS OF TERMS

For convenience of explanation, the following symbols/abbreviations/terms may be used interchangeably in the present disclosure.
QDC: Quantum Direct Communication
QSDC: Quantum Secure Direct Communication
QBER: Quantum Bit Error Rate
QKD: Quantum Key Distribution
MIMA: Man-in-middle-attack
MAC: Message Authentication Code
WCA: Wegman-Carter Authentication
OTP: One Time Pad
ITS: Information Theoretically Secure

The present disclosure proposes methods for resolving the following problems to be solved.

(1) Unlike QKD, the QDC method has no symmetric key information that can be used as a preshared key for authentication, which makes the preshared key updating method used in QKD unavailable, and therefore there arise a need for a separate preshared key updating method that can be used in the QDC method.

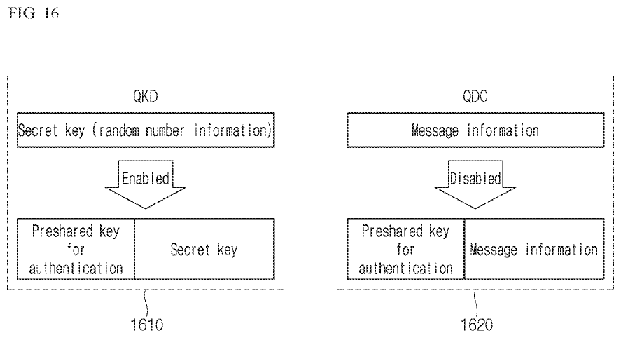

FIG. 16 is a view for describing that information transmitted over a quantum channel in the QDC method cannot be used for updating a preshared key.

In QKD (1610), random numbers are transmitted via a quantum channel, and a final key is generated using random numbers known only to the transmitting/receiving ends, whose security is verified through a process of post-processing the transmitted random numbers. In this case, only some of generated final keys are used for the purpose of updating a preshared key already used for user authentication to a preshared key for use the next time user authentication is performed, and the remaining final keys may be used as a secret key for encrypting a transmission message.

On the other hand, in QDC (1620), message information transmitted over a quantum channel is, in itself, message information the transmitting end intends to send to the receiving end. Thus, separating part of the message information and using it as a preshared key means loss of message information the transmitting end intends to send to the receiving end. Accordingly, when separating part of the message information and using it as a preshared key, the transmitting end is not able to deliver complete information to the receiving end. Therefore, the present disclosure proposes a preshared key updating method that is applicable in user authentication in the QDC technique in which messages are transmitted over a quantum channel.

(2) In the existing symmetric key-based authentication method in quantum communication, such as QKD, some of final generated secret symmetric keys are used for updating a preshared key, and thus more secret keys than used for data encryption are virtually generated, which brings about a need for additional resources for authentication between the transmitting and receiving ends.

In the QKD method, some of secret keys transmitted over a quantum channel are used as a preshared key value which is one time pad information used for user authentication. However, the length of a secret key used for data encryption is fixed, and, consequently, the QKD system may be configured to include an authentication process in which the transmitting end generates longer secret key information for authentication and shares it with the receiving end. However, considering that, in single photon-based quantum communication, a mean photon number of a weak coherence pulse is generally a value less than 1, the transmitting end practically has to transmit multiple bits of quantum information over a quantum channel in order to share a single bit of authentication information (for example, for a mean photon number of 0.1, the transmitting end has to send authentication information 10 times to enable the receiving end to receive a single bit of authentication information), thus wasting a lot of resources due to the information that needs to be additionally generated for the authentication process. Accordingly, the present disclosure proposes a method that can minimize resource waste through such a method as reusing existing resources, without generating information to be used for updating a preshared key used in the authentication process.

The present disclosure deals with a process of user authentication in a QDC protocol which is a technique of securely delivering a classical message directly via a quantum channel. In the user authentication process, a preshared key is previously shared between the transmitting and receiving ends in order to maximize security, and the previously shared preshared key is applied for one-time use in the form of OTP in the user authentication process. In this case, it is essential to update the preshared key to a new value after one-time user authentication, in order to guarantee the security of the authentication process.

As explained earlier, in QKD, some of final generated secret keys are used as a preshared key, whereas, in other quantum communication methods such as QDC, secret keys are not generated, which makes the preshared key updating method used in QKD unavailable. The present disclosure proposes an efficient preshared key updating method that can use QBER checking sequence information transmitted over a quantum channel as a preshared key, in order to check the presence of an eavesdropper in the QDC technique.

Method for Updating Preshared Key using OBER Checking Sequence

Hereinafter, a method for updating a preshared key using QBER checking sequence information will be described. A QBER estimation process for checking the presence of an eavesdropper on a quantum channel is implemented using information for QBER checking, which is information distinct from transmission information, and the information for QBER checking is information that is discarded after the QBER estimation process.

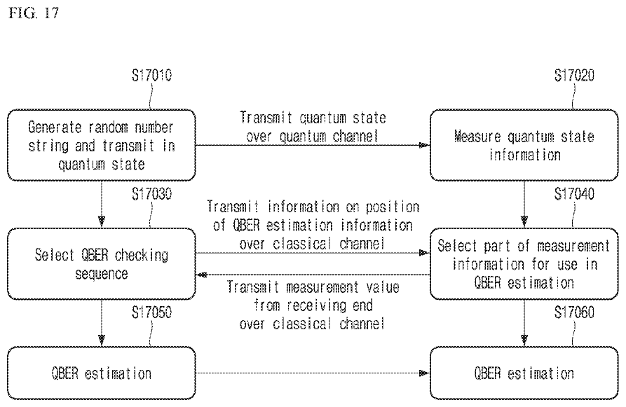

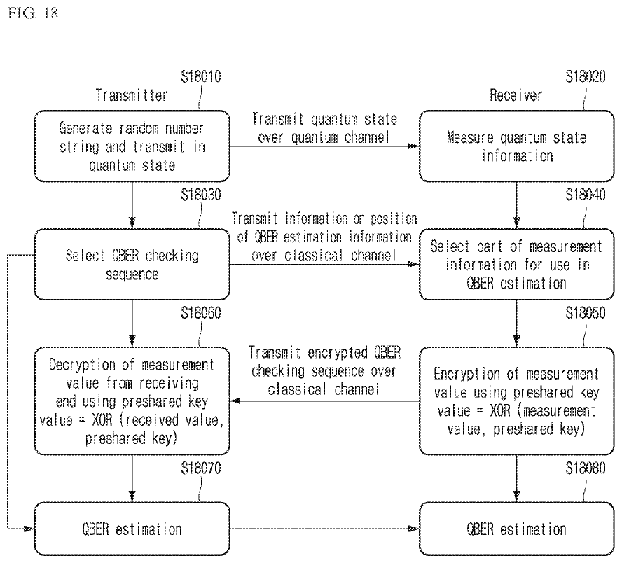

FIG. 17 is a view showing an example of a QBER estimation process performed in the QDC method. FIG. 17 relates to a QBER estimation process in the existing QDC method to which a method proposed in the present disclosure is not applied. Referring to FIG. 17, the transmitting end generates a random number string, and transmits, to the receiving end, quantum state information generated by polarization coding of the generated random number string (S17010). Afterwards, the receiving end measures the quantum state information received from the transmitting end (S17020). Next, the transmitting end selects a QBER checking sequence used for QBER estimation from the generated quantum state information, and transmits, to the receiving end, information on the position of QBER estimation information used for QBER estimation via a classical channel (S17030). Here, the information on the position of QBER estimation information may be information on the position of a QBER checking sequence used for QBER estimation within the quantum state information generated by the transmitting end. Afterwards, based on the information on the position of QBER estimation information received from the transmitting end, the receiving end selects, as information used for QBER estimation, part of measurement information obtained by measuring the quantum state information received in the step S17020, and transmits the selected information used for QBER estimation to the transmitting end over a classical channel (S17040). Afterwards, the transmitting end may calculate the QBER by comparing the information selected in the step S17030 and the information received from the receiving end in the step S17040, and determine the presence of an eavesdropper on a quantum channel according to a comparison result by comparing the calculated QBER and a preset QBER threshold. Incidentally, in the step S17040, the receiving end makes public the measurement value of the QBER checking information via a classical channel, and therefore the QBER checking information the receiving end transmits via a classical channel is not information whose security is guaranteed. That is, if the QBER checking information measured by the receiving end is transmitted via a classical channel, a man-in-the-middle, as well as the transmitting end and the receiving end, is able to access the QBER checking information, which may lead the man-in-the-middle to success in authentication, as well as the agreed transmitting and receiving ends, if the QBER checking information is used as a preshared key applied in user authentication. Accordingly, in the QBER estimation process in FIG. 17, there is a chance that the QBER checking information made public via a classical channel might be revealed to the man-in-the-middle, and therefore the QBER checking information cannot be used as an updated value of the preshared key which is the most important factor in relation to the security of the user authentication method.

In order to solve the problem of the QBER checking information being not usable as an updated value of the preshared key for user authentication, which occurs when the QBER estimation method in FIG. 17 is followed, a method proposed in the present disclosure uses a scheme in which the QBER checking information of the receiving end is encrypted at the receiving end and transmitted over a classical channel, and the transmitting end decrypts the encrypted QBER checking information.

Referring to FIG. 18, the QBER estimation process in the method proposed in the present disclosure will be described in concrete detail.

FIG. 18 is a view showing an example of a QBER estimation process in a method proposed in the present disclosure. Referring to FIG. 18, the transmitting end generates a random number string and transmits, to the receiving end, quantum state information generated by polarization coding of the generated random number string (S18010). Afterwards, the receiving end measures the quantum state information received from the transmitting end (S18020). Next, the transmitting end selects a QBER checking sequence to be used for QBER estimation from the generated quantum state information, and transmits, to the receiving end, information on the position of QBER estimation information used for QBER estimation via a classical channel (S18030). Here, the information on the position of QBER estimation information may be information on the position of a QBER checking sequence used for QBER estimation within the quantum state information generated by the transmitting end. Afterwards, based on the information on the position of QBER estimation information received from the transmitting end, the receiving end selects, as information used for QBER estimation, part of measurement information obtained by measuring the quantum state information received in the step S18020 (S18040). Next, the receiving end encrypts the information (QBER checking sequence) used for QBER estimation selected in the step S18040 by using a preshared key (S18050). In this case, the encryption of the information (QBER checking sequence) used for QBER estimation selected in the step S18040 may be performed through an XOR operation between (i) the information used for QBER estimation selected in the step S18040 and (ii) the preshared key. More specifically, the encryption at the receiving end may be performed according to the following equation:

Encrypted QBER checking sequence=XOR(Measurement value of QBER checking sequence,Preshared key) [Equation 1]

Afterwards, the receiving end transmits, to the transmitting end, the encrypted information (QBER checking sequence) used for QBER estimation over a classical channel (S18050).

The transmitting end decrypts the encrypted information (QBER checking sequence) used for QBER estimation received from the receiving end by using the preshared key (S18060). In this case, the decryption of the encrypted information (QBER checking sequence) used for QBER estimation received from the receiving end may be performed through an XOR operation between (i) the encrypted information (QBER checking sequence) used for QBER estimation and (ii) the preshared key. More specifically, the decryption at the transmitting end of the encrypted information (QBER checking sequence) used for QBER estimation may be performed according to the following equation.

Decrypted QBER checking sequence=XOR(Measurement value of encrypted QBER checking sequence received from receiving end, Preshared key) [Equation 2]

Next, the transmitting end may calculate the QBER by comparing (i) the information selected in the step S18030 and (ii) the encrypted information (QBER checking sequence) used for QBER estimation received from the receiving end in the step S18060, and determine the presence of an eavesdropper on a quantum channel according to a comparison result by comparing the calculated QBER and a preset QBER threshold. In the method of FIG. 18, the QBER checking sequence needs to be encrypted and decrypted using the same information so that the transmitting and receiving ends acquire the same QBER checking sequence, and therefore, the encryption of the QBER checking sequence and the decryption of the encrypted QBER checking sequence are performed by using a preshared key previously shared equally between the transmitting and receiving ends.

Through the method explained in FIG. 18, the receiving end transmits the encrypted QBER checking sequence over a classical channel, and therefore, even if a man-in-the-middle finds information transmitted over the classical channel, the man-in-the-middle is not able to infer the value of the QBER checking sequence from the information transmitted over the classical channel because the man-in-the-middle does not have a preshared key value, and accordingly, the security of the QBER checking sequence transmitted over the classical channel is guaranteed. Once the QBER checking sequence measured by the receiving end is securely shared with the transmitting end through encryption, and it is confirmed that there is no eavesdropper, the security of the QBER checking sequence against the man-in-the-middle is guaranteed. Thus, the QBER checking sequence whose security is guaranteed may be used to update the preshared key for use the next time user authentication is performed between the transmitting and receiving ends.

### User Authentication Procedure Including Preshared Key Updating Process Using OBER Checking Sequence Information

Hereinafter, an overall process of a user authentication procedure including the above-described preshared key updating process using QBER checking sequence information will be described.

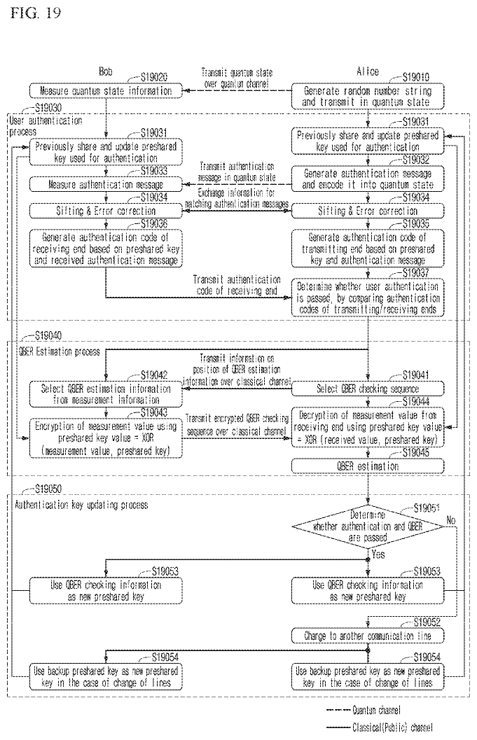

FIG. 19 is a flowchart showing an example of implementation of a user authentication procedure based on a preshared key updating process using QBER checking sequence information, proposed in the present disclosure.

First, the transmitting end, Alice, generates a random number string, and transmits, to the receiving end, Bob, quantum state information generated by polarization coding of the generated random number string over a quantum channel (S19010). Afterwards, the receiving end, Bob, measures the quantum state information received from the transmitting end (S19020). Next, the transmitting end, Alice, and the receiving end, Bob, perform a user authentication process (S19030). Details of the user authentication process (S19030) will be described first below.

S19030: At the time of initial authentication between the transmitting end. Alice, and the receiving end. Bob, a preshared key used for authentication is previously shared between the transmitting end, Alice, and the receiving end, Bob (S19031). For a subsequent authentication between the transmitting end, Alice, and the receiving end, Bob, that occurs after the initial authentication, the preshared key which is previously used may be updated to a new preshared key value in the step S19031, and the updated preshared key may be used for authentication between the transmitting end, Alice, and the receiving end, Bob. The preshared key previously shared or updated in the step S19031 is used in the QBER estimation step S19040 to be described later. In particular, the preshared key previously shared or updated in the step S19031 is used for the receiving end, Bob, to encrypt the QBER checking sequence and for the transmitting end, Alice, to decrypt the encrypted QBER checking sequence, in the step S19040. In the step S19031, the preshared key needs to be previously shared and updated before the start of the user authentication process, and the step S19031 may be performed earlier than the step S19010 and/or the step S19020, although FIG. 19 illustrates it as the first step of the user authentication process.

Next, the transmitting end. Alice, generates an authentication message for authentication, and generates a quantum state by polarization coding of the generated authentication message and then transmits it to the receiving end, Bob, over a quantum channel (S19032). Afterwards, the receiving end. Bob, receives and measures the authentication message transmitted in a quantum state (S19033). Next, the transmitting end, Alice, and the receiving end, Bob, exchange information for matching their authentication messages (S19034), because the authentication will fail if the authentication message used by the transmitting end, Alice, to generate an authentication code and the authentication message used by the receiving end, Bob, to generate an authentication code are different from each other. In this case, sifting and error correction may be performed. Next, the transmitting end, Alice, and the receiving end, Bob, each generate an authentication code based on the preshared key and the authentication message (S19035 and S19036). Afterwards, the receiving end, Bob, transmits the authentication code generated by the receiving end, Bob, to the transmitting end. Alice, and the transmitting end. Alice, determines whether the user authentication is passed, by comparing the authentication code of the receiving end, Bob, received from the receiving end, Bob, and the authentication code generated by the transmitting end, Alice (S19037).

After the step S19030, the transmitting end, Alice, and the receiving end, Bob, perform a QBER estimation process (S19040). Details of the QBER estimation process will be discussed below.

S19040: First, the transmitting end, Alice, selects a QBER checking sequence used for QBER estimation from the quantum state information generated in the step S9010, and transmits, to the receiving end, Bob, information on the position of QBER estimation information used for QBER estimation via a classical channel (S19041). Here, the information on the position of QBER estimation information may be information on the position of a QBER checking sequence used for QBER estimation within the quantum state information generated by the transmitting end. Afterwards, based on the information on the position of QBER estimation information received from the transmitting end, Alice, the receiving end. Bob, selects, as information used for QBER estimation, part of measurement information obtained by measuring the quantum state information received in the step S19020 (S19042). Next, the receiving end, Bob, encrypts the information (QBER checking sequence) used for QBER estimation selected in the step S19042 by using the preshared key previously shared or updated in the step S19031 (S19043). In this case, the encryption of the information (QBER checking sequence) used for QBER estimation selected in the step S19042 may be performed through an XOR operation between (i) the information used for QBER estimation selected in the step S19042 and (ii) the preshared key. Afterwards, the receiving end, Bob, transmits, to the transmitting end, Alice, the encrypted information (QBER checking sequence) used for QBER estimation over a classical channel (S19043).

The transmitting end, Alice, decrypts the encrypted information (QBER checking sequence) used for QBER estimation received from the receiving end, Bob, by using the preshared key (S19044). In this case, the decryption of the encrypted information (QBER checking sequence) used for QBER estimation the transmitting end, Alice, receives from the receiving end, Bob, may be performed through an XOR operation between (i) the encrypted information (QBER checking sequence) used for QBER estimation and (ii) the preshared key. Next, the transmitting end, Alice, may calculate the QBER by comparing (i) the information selected in the step S19041 and (ii) the encrypted information (QBER checking sequence) used for QBER estimation received from the receiving end, Bob, in the step S19044, and determine the presence of an eavesdropper on a quantum channel according to a comparison result by comparing the calculated QBER and a preset QBER threshold.

After the step S19040, the transmitting end, Alice, and the receiving end. Bob, perform a preshared key updating process (S19050). Details of the preshared key updating process will be described below.

S19050. The transmitting end, Alice, determines whether the user authentication and the QBER estimation are passed (S19051). If both the user authentication and the QBER estimation are passed (successful), the transmitting end, Alice, and the receiving end, Bob, use the QBER checking sequence information used for the QBER estimation process as a preshared key that replaces the existing preshared key (S19053). That is, the existing preshared key is updated to the QBER checking sequence information used for the QBER estimation process. The QBER checking sequence information used for the QBER estimation process, in itself, is used as a preshared key. The length of a portion selected as the preshared key from the QBER checking sequence may be determined according to security criteria for the authentication technique, and the preshared key to be selected becomes longer as the reference value becomes higher, and therefore a larger proportion of the QBER checking sequence is selected as the preshared key. Additionally, if both the user authentication and the QBER estimation succeed but the value of the QBER estimation is not zero—that is, there is a difference between the value of the QBER checking sequence selected by the transmitting end, Alice, and the value of the QBER checking sequence measured by the receiving end, Bob, even when there is no man-in-the-middle deemed as an eavesdropper, the transmitting end, Alice, and the receiving end, Bob, may perform an additional procedure for matching the value of the QBER checking sequence selected by the transmitting end, Alice, and the value of the QBER checking sequence measured by the receiving end, Bob.

On the contrary, if neither the user authentication nor the QBER estimation is passed, there may be an intervention from a man-in-the-middle, and therefore the communication line is changed to another communication line (S19052). When the communication line is changed to another communication line, a backup preshared key may be used as a new preshared key (S19054). Accordingly, when the preshared key is previously shared in the step S19031, the backup preshared key may be shared as well in case neither the user authentication nor the QBER estimation is passed, as in the step S19052. There may be at least one backup preshared key. Also, if neither the user authentication nor the QBER estimation is passed multiple times and therefore there is no available backup preshared key any longer, a procedure for sharing a new initial preshared key and an additional backup preshared key may be performed between the transmitting end, Alice, and the receiving end, Bob.

Procedure in ODC Protocol Including User Authentication Process to which Preshared Key Updating Method is Applied

In such a conventional user authentication method as QKD in which a secret key is generated, a preshared key may be generated/updated using a secret key, whereas, in a quantum communication method where no secret key is generated, user authentication may not be performed by the conventional user authentication method. Thus, the above-described authentication method in which checking sequence information used for QBER estimation is used as a preshared key may be used more preferably in such a quantum communication method as QDC in which no secret key is used.

Hereinafter, a description will be given of an overall process of how a QDC protocol works when a user authentication and preshared key updating method proposed in the present disclosure are applied to two types of QDC: one-way and two-way schemes.

### Procedure in Two Way ODC (=DL04 OSDC) Protocol

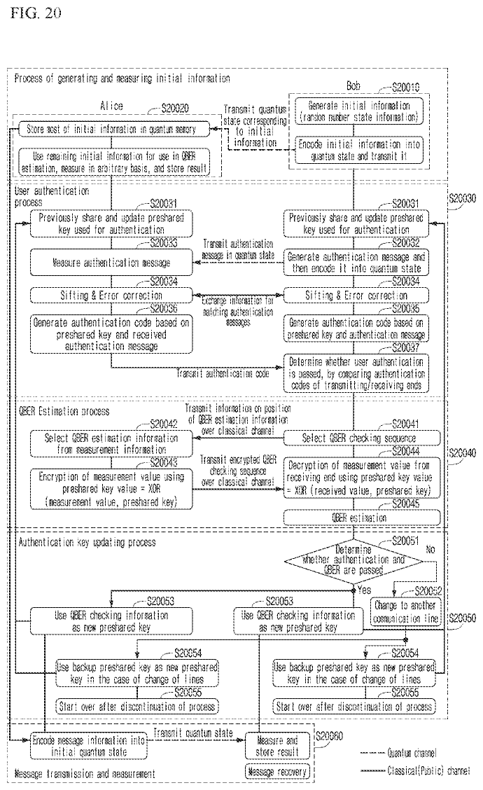

FIG. 20 is a flowchart showing a procedure in a two way QDC protocol to which a method proposed in the present disclosure is applied.

First, the receiving end, Bob, generates initial information, encodes the generated initial information into a quantum state, and transmits it to the transmitting end, Alice (S20010). Next, the transmitting end, Alice, stores most of the received initial information in a quantum memory, and uses the remaining information for use in QBER estimation, except for the information stored in the quantum memory. In this case, the transmitting end, Alice, measures the information received from the receiving end, Bob, in an arbitrary basis, and stores a measurement result (S20020).

Next, the transmitting end, Alice, and the receiving end, Bob, perform a user authentication process (S20030). Details of the user authentication process S20030 will be described first below.

S20030: At the time of initial authentication between the transmitting end. Alice, and the receiving end. Bob, a preshared key used for authentication is previously shared between the transmitting end, Alice, and the receiving end, Bob (S20031). For a subsequent authentication between the transmitting end, Alice, and the receiving end, Bob, that occurs after the initial authentication, the preshared key which is previously used may be updated to a new preshared key value in the step S20031, and the updated preshared key may be used for authentication between the transmitting end, Alice, and the receiving end, Bob. The preshared key previously shared or updated in the step S20031 is used in the QBER estimation step S20040 to be described later. In particular, the preshared key previously shared or updated in the step S20031 is used for the receiving end, Bob, to encrypt the QBER checking sequence and for the transmitting end, Alice, to decrypt the encrypted QBER checking sequence, in the step S20040. In the step S20031, the preshared key needs to be previously shared and updated before the start of the user authentication process, and the step S20031 may be performed earlier than the step S20010 and/or the step S20020, although FIG. 20 illustrates it as the first step of the user authentication process.

Next, the receiving end, Bob, generates an authentication message for authentication, and generates a quantum state by polarization coding of the generated authentication message and then transmits it to the transmitting end, Alice, over a quantum channel (520032). Afterwards, the transmitting end, Alice, receives and measures the authentication message transmitted in a quantum state (S20033). Next, the transmitting end, Alice, and the receiving end, Bob, exchange information for matching their authentication messages (S20034), because the authentication will fail if the authentication message used by the transmitting end. Alice, to generate an authentication code and the authentication message used by the receiving end, Bob, to generate an authentication code are different from each other. In this case, sifting and error correction may be performed. Next, the transmitting end, Alice, and the receiving end, Bob, each generate an authentication code based on the preshared key and the authentication message (S20035 and S20036). Afterwards, the transmitting end, Alice, transmits the authentication code generated by the transmitting end, Alice, to the receiving end, Bob, and the receiving end, Bob, determines whether the user authentication is passed, by comparing the authentication code of the transmitting end, Alice, received from the transmitting end, Alice, and the authentication code generated by the receiving end, Bob (S20037).

After the step S20030, the transmitting end. Alice, and the receiving end, Bob, perform a QBER estimation process (S20040). Details of the QBER estimation process will be discussed below.

S20040: First, the receiving end, Bob, selects a QBER checking sequence used for QBER estimation from the quantum state information generated in the step S20010, and transmits, to the transmitting end, Alice, information on the position of QBER estimation information used for QBER estimation via a classical channel (S20041). Here, the information on the position of QBER estimation information may be information on the position of a QBER checking sequence used for QBER estimation within the quantum state information generated by the transmitting end. Afterwards, based on the information on the position of QBER estimation information received from the receiving end, Bob, the transmitting end. Alice, selects, as information used for QBER estimation, part of measurement information obtained by measuring the quantum state information received in the step S20020 (S20042). Next, the transmitting end, Alice, encrypts the information (QBER checking sequence) used for QBER estimation selected in the step S20042 by using the preshared key previously shared or updated in the step S20031 (S20043). In this case, the encryption of the information (QBER checking sequence) used for QBER estimation selected in the step S20042 may be performed through an XOR operation between (i) the information used for QBER estimation selected in the step S20042 and (ii) the preshared key. Afterwards, the transmitting end, Alice, transmits, to the receiving end, Bob, the encrypted information (QBER checking sequence) used for QBER estimation over a classical channel (S20043).

The receiving end, Bob, decrypts the encrypted information (QBER checking sequence) used for QBER estimation received from the transmitting end, Alice, by using the preshared key (S20040). In this case, the decryption of the encrypted information (QBER checking sequence) used for QBER estimation the receiving end, Bob, receives from the transmitting end, Alice, may be performed through an XOR operation between (i) the encrypted information (QBER checking sequence) used for QBER estimation and (ii) the preshared key. Next, the receiving end, Bob, may calculate the QBER by comparing (i) the information selected in the step S20041 and (ii) the encrypted information (QBER checking sequence) used for QBER estimation received from the transmitting end. Alice, in the step S20044, and determine the presence of an eavesdropper on a quantum channel according to a comparison result by comparing the calculated QBER and a preset QBER threshold.

After the step S20040, the transmitting end, Alice, and the receiving end. Bob, perform a preshared key updating process (S20050). Details of the preshared key updating process will be described below.

S20050: The receiving end, Bob, determines whether the user authentication and the QBER estimation are passed (S20051). If both the user authentication and the QBER estimation are passed (successful), the transmitting end, Alice, and the receiving end, Bob, use the QBER checking sequence information used for the QBER estimation process as a preshared key that replaces the existing preshared key (S20053). That is, the existing preshared key is updated to the QBER checking sequence information used for the QBER estimation process. The QBER checking sequence information used for the QBER estimation process, in itself, is used as a preshared key. The length of a portion selected as the preshared key from the QBER checking sequence may be determined according to security criteria for the authentication technique, and the preshared key to be selected becomes longer as the reference value becomes higher, and therefore a larger proportion of the QBER checking sequence is selected as the preshared key. Afterwards, the transmitting end, Alice, and the receiving end, Bob, perform a message transmission and measurement process (S20060). In the step S20060, the transmitting end, Alice, encodes message information in an initial quantum state and transmits it to the receiving, Bob, over a quantum channel, and the receiving end, Bob, performs measurement and recovers the message by storing a result.

Additionally, if both the user authentication and the QBER estimation succeed but the value of the QBER estimation is not zero, —that is, there is a difference between the value of the QBER checking sequence selected by the receiving end, Bob, and the value of the QBER checking sequence measured by the transmitting end, Alice, even when there is no man-in-the-middle deemed as an eavesdropper, the transmitting end, Alice, and the receiving end, Bob, may perform an additional procedure for matching the value of the QBER checking sequence selected by the receiving end, Bob, and the value of the QBER checking sequence measured by the transmitting end, Alice.

On the contrary, if neither the user authentication nor the QBER estimation is passed, there may be an intervention from a man-in-the-middle, and therefore the communication line is changed to another communication line (S20052). When the communication line is changed to another communication line, a backup preshared key may be used as a new preshared key (S20054). Afterwards, the transmitting end, Alice, and the receiving end, Bob, may discontinue the transmission process and start the procedure for message transmission over from the step S20010.

When the preshared key is previously shared in the step S20031, the backup preshared key may be shared as well in case neither the user authentication nor the QBER estimation is passed, as in the step S20052. There may be at least one backup preshared key. Also, if neither the user authentication nor the QBER estimation is passed multiple times and therefore there is no available backup preshared key any longer, a procedure for sharing a new initial preshared key and an additional backup preshared key may be performed between the transmitting end, Alice, and the receiving end, Bob.

### Procedure in One Way ODC Protocol

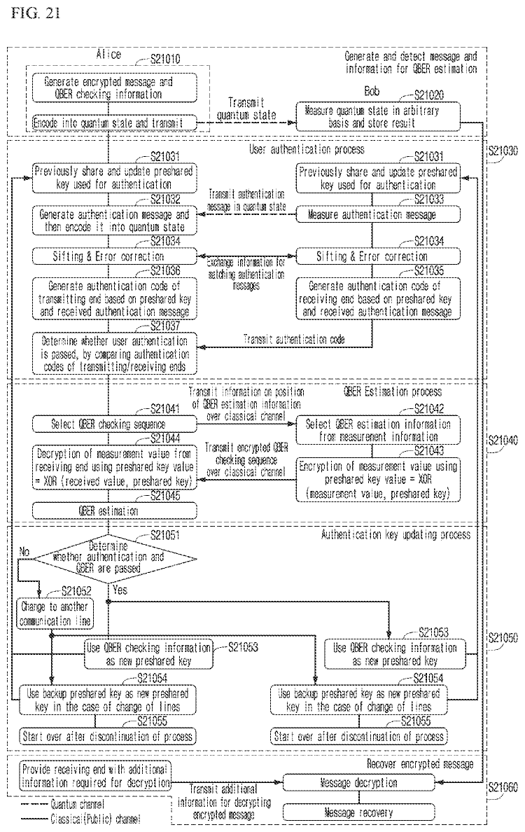

FIG. 21 is a flowchart showing a procedure in a one way QDC protocol to which a method proposed in the present disclosure is applied.

First, the transmitting end, Alice, generates an encrypted message and QBER checking information, encodes the generated information into a quantum state, and transmits it to the receiving end, Bob, over a quantum channel (S21010). Next, the receiving end, Bob, measures the received quantum state in an arbitrary basis, and stores a measurement result (S21020).

Next, the transmitting end, Alice, and the receiving end. Bob, perform a user authentication process (S21030). Details of the user authentication process S21030 will be described first below.

S21030: At the time of initial authentication between the transmitting end, Alice, and the receiving end, Bob, a preshared key used for authentication is previously shared between the transmitting end, Alice, and the receiving end, Bob (S21031). For a subsequent authentication between the transmitting end, Alice, and the receiving end, Bob, that occurs after the initial authentication, the preshared key which is previously used may be updated to a new preshared key value in the step S21031, and the updated preshared key may be used for authentication between the transmitting end, Alice, and the receiving end, Bob. The preshared key previously shared or updated in the step S21031 is used in the QBER estimation step S21040 to be described later. In particular, the preshared key previously shared or updated in the step S21031 is used for the receiving end, Bob, to encrypt the QBER checking sequence and for the transmitting end, Alice, to decrypt the encrypted QBER checking sequence, in the step S21040. In the step S21031, the preshared key needs to be previously shared and updated before the start of the user authentication process, and the step S21031 may be performed earlier than the step S21010 and/or the step S21020, although FIG. 21 illustrates it as the first step of the user authentication process.

Next, the transmitting end, Alice, generates an authentication message for authentication, and generates a quantum state by polarization coding of the generated authentication message and then transmits it to the receiving end, Bob, over a quantum channel (S21032). Afterwards, the receiving end, Bob, receives and measures the authentication message transmitted in a quantum state (S21033). Next, the transmitting end, Alice, and the receiving end, Bob, exchange information for matching their authentication messages (S21034), because the authentication will fail if the authentication message used by the transmitting end, Alice, to generate an authentication code and the authentication message used by the receiving end, Bob, to generate an authentication code are different from each other. In this case, sifting and error correction may be performed. Next, the transmitting end, Alice, and the receiving end, Bob, each generate an authentication code based on the preshared key and the authentication message (S21035 and S21036). Afterwards, the receiving end, Bob, transmits the authentication code generated by the receiving end, Bob, to the transmitting end, Alice, and the transmitting end, Alice, determines whether the user authentication is passed, by comparing the authentication code of the receiving end, Bob, received from the receiving end, Bob, and the authentication code generated by the transmitting end, Alice (S21037).

After the step S21030, the transmitting end, Alice, and the receiving end, Bob, perform a QBER estimation process (S21040). Details of the QBER estimation process will be discussed below.

S21040: First, the transmitting end. Alice, selects a QBER checking sequence used for QBER estimation from the quantum state information generated in the step S21010, and transmits, to the receiving end, Bob, information on the position of QBER estimation information used for QBER estimation via a classical channel (S21041). Here, the information on the position of QBER estimation information may be information on the position of a QBER checking sequence used for QBER estimation within the quantum state information generated by the transmitting end. Afterwards, based on the information on the position of QBER estimation information received from the transmitting end, Alice, the receiving end, Bob, selects, as information used for QBER estimation, part of measurement information obtained by measuring the quantum state information received in the step S21020 (S21042). Next, the receiving end, Bob, encrypts the information (QBER checking sequence) used for QBER estimation selected in the step S21042 by using the preshared key previously shared or updated in the step S21031 (S21043). In this case, the encryption of the information (QBER checking sequence) used for QBER estimation selected in the step S21042 may be performed through an XOR operation between (i) the information used for QBER estimation selected in the step S21042 and (ii) the preshared key. Afterwards, the receiving end, Bob, transmits, to the transmitting end, Alice, the encrypted information (QBER checking sequence) used for QBER estimation over a classical channel (S21043).

The transmitting end. Alice, decrypts the encrypted information (QBER checking sequence) used for QBER estimation received from the receiving end, Bob, by using the preshared key (S21044). In this case, the decryption of the encrypted information (QBER checking sequence) used for QBER estimation the transmitting end, Alice, receives from the receiving end, Bob, may be performed through an XOR operation between (i) the encrypted information (QBER checking sequence) used for QBER estimation and (ii) the preshared key. Next, the transmitting end, Alice, may calculate the QBER by comparing (i) the information selected in the step S21041 and (ii) the encrypted information (QBER checking sequence) used for QBER estimation received from the receiving end, Bob, in the step S21044, and determine the presence of an eavesdropper on a quantum channel according to a comparison result by comparing the calculated QBER and a preset QBER threshold.

After the step S21040, the transmitting end, Alice, and the receiving end, Bob, perform a preshared key updating process (S21050). Details of the preshared key updating process will be described below.

S21050: The transmitting end, Alice, determines whether the user authentication and the QBER estimation are passed (S21051). If both the user authentication and the QBER estimation are passed (successful), the transmitting end, Alice, and the receiving end, Bob, use the QBER checking sequence information used for the QBER estimation process as a preshared key that replaces the existing preshared key (S21053). That is, the existing preshared key is updated to the QBER checking sequence information used for the QBER estimation process. Afterwards, the transmitting end, Alice, and the receiving end, Bob, perform a message transmission and measurement process (S21060). In the step S21060, the transmitting end, Alice, transmits additional information required for message decryption to the receiving end, Bob, and the receiving end, Bob, recovers the message by decrypting the message based on the additional information.

The QBER checking sequence information used for the QBER estimation process, in itself, is used as a preshared key. The length of a portion selected as the preshared key from the QBER checking sequence may be determined according to security criteria for the authentication technique, and the preshared key to be selected becomes longer as the reference value becomes higher, and therefore a larger proportion of the QBER checking sequence is selected as the preshared key. Additionally, if both the user authentication and the QBER estimation succeed but the value of the QBER estimation is not zero, —that is, there is a difference between the value of the QBER checking sequence selected by the transmitting end, Alice, and the value of the QBER checking sequence measured by the receiving end, Bob, even when there is no man-in-the-middle deemed as an eavesdropper, the transmitting end, Alice, and the receiving end, Bob, may perform an additional procedure for matching the value of the QBER checking sequence selected by the transmitting end, Alice, and the value of the QBER checking sequence measured by the receiving end, Bob.

On the contrary, if neither the user authentication nor the QBER estimation is passed, there may be an intervention from a man-in-the-middle, and therefore the communication line is changed to another communication line (S21052). When the communication line is changed to another communication line, a backup preshared key may be used as a new preshared key (S21054). Afterwards, the transmitting end, Alice, and the receiving end, Bob, may discontinue the transmission process and start the procedure for message transmission over from the step S21010.

When the preshared key is previously shared in the step S21031, the backup preshared key may be shared as well in case neither the user authentication nor the QBER estimation is passed, as in the step S21052. There may be at least one backup preshared key. Also, if neither the user authentication nor the QBER estimation is passed multiple times and therefore there is no available backup preshared key any longer, a procedure for sharing a new initial preshared key and an additional backup preshared key may be performed between the transmitting end, Alice, and the receiving end, Bob.

### Effects

According to the above-described methods proposed in the present disclosure, the following effects may be achieved.

First, although a QKD-based authentication method allows for updating a preshared key using a secret key, QDC is not capable of generating secret keys, which makes the QKD-based authentication method inapplicable to QDC, and this problem can be solved by updating the preshared key

More specifically, quantum communication authentication technology is available for discussion only when the authentication method is suitable for QKD, which is currently a commercially available technology. Thus, the preshared key updating method may be deployed in such a manner that an overall process of a QKD protocol is carried out and then some of the same symmetric secret keys shared between the transmitting and receiving ends are used as a new preshared key for use the next time user authentication is performed. However, the preshared key updating method used in the QKD protocol is not available in quantum communication techniques, except QKD, where no secret keys are generated. To solve this problem, the present disclosure proposes a method in which an encryption scheme is applied to a QBER checking sequence used for a QBER estimation process in a quantum direct communication (QDC) method where no symmetric secret keys are used, in order to transmit classical information, which prevents the QBER checking sequence from being revealed to a main-in-the-middle, so that the QBER checking sequence can be used as a preshared key, and this explains that a preshared key-based authentication method is also applicable to a QDC method in which no secret keys are used.

Next, according to a method proposed in the present disclosure, information to be discarded after a QBER estimation process is used as a preshared key for an authentication process, and therefore no additional information for updating the preshared key is generated, thereby eliminating the need for additional resource allocation for the authentication process and resulting in resource reduction.

More specifically, in the existing authentication method deployed in QKD, it is necessary to generate much larger amounts of information than secret keys practically used as a preshared key to generate a certain amount of information. However, in a single photon-based quantum communication technique, generating much larger amounts of information than secret keys practically used as a preshared key to generate a certain amount of information may impose a large burden in term of information generation, considering that a considerable amount of signals produced by light sources to generate a single photon is lost during the transmission process. However, in a method proposed in the present disclosure, information to be discarded after used in a QBER estimation process is used to generate information for updating the preshared key, and therefore no additional information for updating the preshared key is generated, thereby eliminating the need for additional resource allocation for the authentication process and resulting in resource reduction.

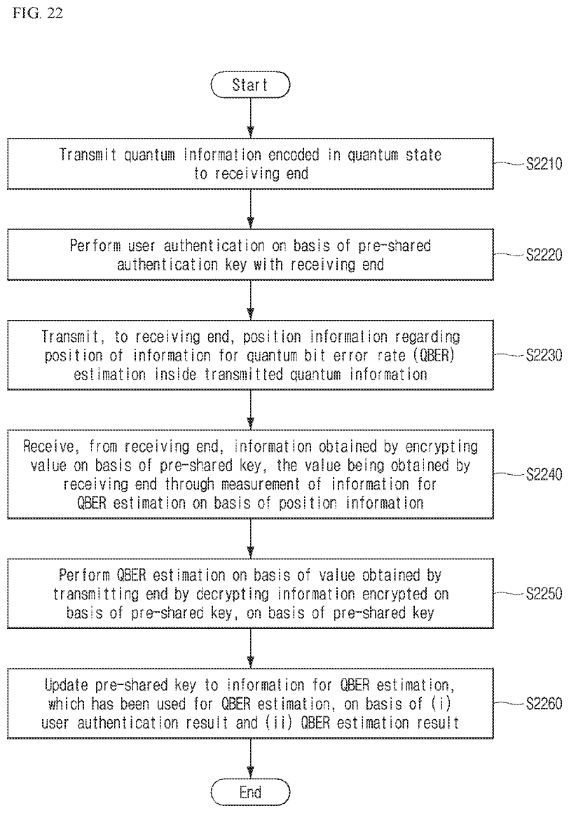

FIG. 22 is a flowchart showing an example of how a user authentication method proposed in the present disclosure is performed by a transmitting end.

More specifically, in order to perform user authentication in a quantum direct communication system, the transmitting end transmits quantum information encoded in a quantum state to a receiving end (S2210).

Next, the transmitting end performs user authentication on the basis of a pre-shared authentication key with the receiving end (S2220).

Afterwards, the transmitting end transmits, to the receiving end, position information regarding the position of information for quantum bit error rate (QBER) estimation inside the transmitted quantum information (S2230).

Next, the transmitting end receives, from the receiving end, information obtained by encrypting a value on the basis of the pre-shared key, the value being obtained by the receiving end through measurement of the information for QBER estimation on the basis of the position information (S2240).

Next, the transmitting end performs the QBER estimation on the basis of a value obtained by the transmitting end by decrypting information encrypted on the basis of the pre-shared key, on the basis of the pre-shared key (52250).

Afterwards, the transmitting end updates the pre-shared key to the information for QBER estimation, which has been used for the QBER estimation, on the basis of (i) the user authentication result and (ii) the QBER estimation result.

Moreover, the transmitting end includes: a transmitter for transmitting a wireless signal; a receiver for receiving a wireless signal; at least one processor; and at least one computer memory operably connectable to the at least one processor, and storing instructions that, when executed by the at least one processor, perform operations. In this case, the operations include the steps described above in FIG. 22.

Additionally, the operations described in FIG. 22 may be stored in a non-transitory computer readable medium (CRM) that stores one or more instructions. The non-transitory computer readable medium stores one or more instructions executable by one or more processors, and the one or more instructions cause the transmitting end to perform the operations described in FIG. 22.

Furthermore, a device including one or more memories and one or more processors functionally connected to the one or more memories controls the one or more processors to perform the operations described in FIG. 22.

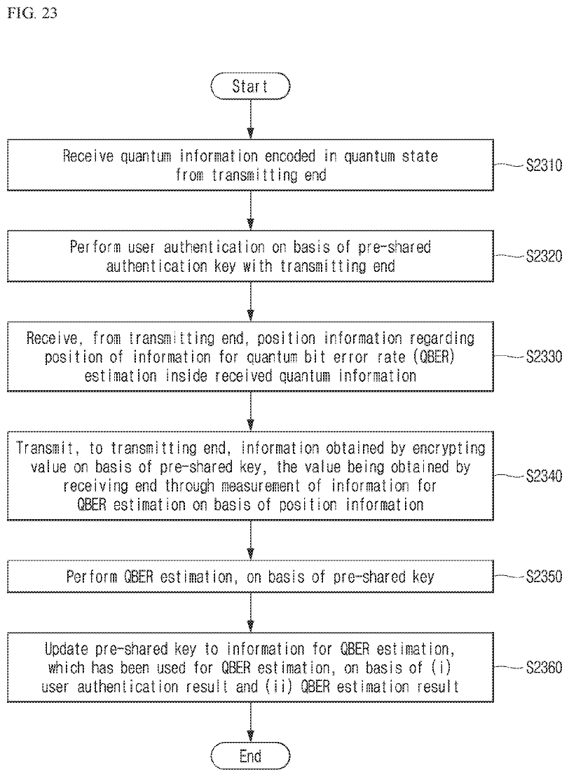

FIG. 23 is a flowchart showing an example of how a user authentication method proposed in the present disclosure is performed by a receiving end.

To perform user authentication in a quantum direct communication system, the receiving end receives, from a transmitting end, quantum information encoded in a quantum state (S2310).

Next, the receiving end performs user authentication on the basis of a pre-shared authentication key with the transmitting end (S2320).

Afterwards, the receiving end receives, from the transmitting end, position information regarding the position of information for quantum bit error rate (QBER) estimation inside the transmitted quantum information (S2330).

Next, the receiving end transmits, to the transmitting end, information obtained by encrypting a value on the basis of the pre-shared key, the value being obtained by the receiving end through measurement of the information for QBER estimation on the basis of the position information (S2340).

Next, the receiving end performs the QBER estimation on the basis of the pre-shared key (S2350). Here, the QBER estimation is performed on the basis of a value obtained by the transmitting end by decrypting information encrypted on the basis of the pre-shared key.

Afterwards, the receiving end updates the pre-shared key to the information for QBER estimation, which has been used for the QBER estimation, on the basis of (i) the user authentication result and (ii) the QBER estimation result (S2360).

Moreover, the receiving end includes: a transmitter for transmitting a wireless signal; a receiver for receiving a wireless signal: at least one processor; and at least one computer memory operably connectable to the at least one processor, and storing instructions that, when executed by the at least one processor, perform operations. In this case, the operations include the steps described above in FIG. 23.

Additionally, the operations described in FIG. 23 may be stored in a non-transitory computer readable medium (CRM) that stores one or more instructions. The non-transitory computer readable medium stores one or more instructions executable by one or more processors, and the one or more instructions cause the receiving end to perform the operations described in FIG. 23.

Furthermore, a device including one or more memories and one or more processors functionally connected to the one or more memories controls the one or more processors to perform the operations described in FIG. 23.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs). Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

Although the present disclosure has been described mainly with respect to an example applied to 3GPP LTE/LTE-A and 5G systems, it may be applied to various wireless communication systems in addition to the 3GPP LTE/LTE-A and 5G systems.

1. A method for a transmitting end to perform user authentication in a quantum direct communication system, the method comprising:
transmitting quantum information encoded in a quantum state to a receiving end;
performing user authentication on the basis of a pre-shared authentication key with the receiving end;
transmitting, to the receiving end, position information regarding the position of information for quantum bit error rate (QBER) estimation inside the transmitted quantum information;
receiving, from the receiving end, information obtained by encrypting a value on the basis of the pre-shared key, the value being obtained by the receiving end through measurement of the information for QBER estimation on the basis of the position information;
performing the QBER estimation on the basis of a value obtained by the transmitting end by decrypting information encrypted on the basis of the pre-shared key, on the basis of the pre-shared key; and
updating the pre-shared key to the information for QBER estimation, which has been used for the QBER estimation, on the basis of (i) the user authentication result and (ii) the QBER estimation result.

2. The method of claim 1, wherein the information obtained by encrypting a value on the basis of the pre-shared key, the value being obtained by the receiving end through measurement of the information for QBER estimation, is a value produced through an XOR operation between (i) the value obtained by the receiving end through measurement of the information for QBER estimation and (ii) the pre-shared key.

3. The method of claim 2, wherein the value obtained by decrypting information encrypted on the basis of the pre-shared key is a value obtained through an XOR operation between (i) the information encrypted on the basis of the pre-shared key, received by the transmitting end and (ii) the pre-shared key.

4. The method of claim 1, wherein the pre-shared key is updated to the information for QBER estimation, which has been used for the QBER estimation, based on (i) the user authentication result and (ii) the QBER estimation result being both successful.

5. The method of claim 4, wherein the quantum information includes (i) the information for QBER estimation and (ii) information obtained by encrypting message information.

6. The method of claim 5, further comprising transmitting, to the receiving end, additional information for decrypting the encrypted message information, based on (i) the user authentication result and (ii) the QBER estimation result being both successful.

7. The method of claim 6, further comprising performing a procedure for matching (i) the value of the information for QBER estimation, generated by the transmitting end and (ii) the value obtained by the transmitting end by decrypting information encrypted by the receiving end on the basis of the pre-shared key, based on (i) the user authentication result and (ii) the QBER estimation result being both successful and (iii) the value of the QBER estimation result not being zero.

8. The method of claim 1, wherein a communication line for quantum communication between the transmitting end and the receiving end is changed, based on at least one of (i) the user authentication result and (ii) the QBER estimation result being a failure.

9. The method of claim 8, wherein the pre-shared key is updated to a backup pre-shared key used for updating the pre-shared key when changing the communication line, based on at least one of (i) the user authentication result and (ii) the QBER estimation result being a failure.

10. The method of claim 9, further comprising exchanging (i) the pre-shared key and (ii) the backup pre-shared key with the receiving end.

11. A transmitting end that performs user authentication in a quantum communication system, the transmitting end comprising:
a transmitter for transmitting a wireless signal;
a receiver for receiving a wireless signal;
at least one processor; and
at least one computer memory operably connectable to the at least one processor, and storing instructions that, when executed by the at least one processor, perform operations,
the operations comprising:
transmitting quantum information encoded in a quantum state to a receiving end;
performing user authentication on the basis of a pre-shared authentication key with the receiving end;
transmitting, to the receiving end, position information regarding the position of information for quantum bit error rate (QBER) estimation inside the transmitted quantum information;
receiving, from the receiving end, information obtained by encrypting a value on the basis of the pre-shared key, the value being obtained by the receiving end through measurement of the information for QBER estimation on the basis of the position information;
performing the QBER estimation on the basis of a value obtained by the transmitting end by decrypting information encrypted on the basis of the pre-shared key, on the basis of the pre-shared key; and
updating the pre-shared key to the information for QBER estimation, which has been used for the QBER estimation, on the basis of (i) the user authentication result and (ii) the QBER estimation result.

12. A method for a receiving end to perform user authentication in a quantum direct communication system, the method comprising:
receiving quantum information encoded in a quantum state from a transmitting end;
performing user authentication on the basis of a pre-shared authentication key with the transmitting end;
receiving, from the transmitting end, position information regarding the position of information for quantum bit error rate (QBER) estimation inside the received quantum information;
transmitting, to the transmitting end, information obtained by encrypting a value on the basis of the pre-shared key, the value being obtained by the receiving end through measurement of the information for QBER estimation on the basis of the position information;
performing the QBER estimation, on the basis of the pre-shared key,
the QBER estimation being performed on the basis of a value obtained by the transmitting end by decrypting information encrypted on the basis of the pre-shared key; and
updating the pre-shared key to the information for QBER estimation, which has been used for the QBER estimation, on the basis of (i) the user authentication result and (ii) the QBER estimation result.

13-15. (canceled)

16. The transmitting end of claim 11, wherein the information obtained by encrypting a value on the basis of the pre-shared key, the value being obtained by the receiving end through measurement of the information for QBER estimation, is a value produced through an XOR operation between (i) the value obtained by the receiving end through measurement of the information for QBER estimation and (ii) the pre-shared key.

17. The transmitting end of claim 16, wherein the value obtained by decrypting information encrypted on the basis of the pre-shared key is a value obtained through an XOR operation between (i) the information encrypted on the basis of the pre-shared key, received by the transmitting end and (ii) the pre-shared key.

18. The transmitting end of claim 11, wherein the pre-shared key is updated to the information for QBER estimation, which has been used for the QBER estimation, based on (i) the user authentication result and (ii) the QBER estimation result being both successful.

19. The transmitting end of claim 18, wherein the quantum information includes (i) the information for QBER estimation and (ii) information obtained by encrypting message information.

20. The transmitting end of claim 19, the operations further comprise: transmitting, to the receiving end, additional information for decrypting the encrypted message information, based on (i) the user authentication result and (ii) the QBER estimation result being both successful.

21. The transmitting end of claim 20, the operations further comprise: performing a procedure for matching (i) the value of the information for QBER estimation, generated by the transmitting end and (ii) the value obtained by the transmitting end by decrypting information encrypted by the receiving end on the basis of the pre-shared key, based on (i) the user authentication result and (ii) the QBER estimation result being both successful and (iii) the value of the QBER estimation result not being zero.

22. The transmitting end of claim 11, wherein a communication line for quantum communication between the transmitting end and the receiving end is changed, based on at least one of (i) the user authentication result and (ii) the QBER estimation result being a failure.

23. The transmitting end of claim 22, wherein the pre-shared key is updated to a backup pre-shared key used for updating the pre-shared key when changing the communication line, based on at least one of (i) the user authentication result and (ii) the QBER estimation result being a failure.
